(19) United States
(12) Patent Application Publication
(10) Pub. No.: US 2023/0318220 A1
(43) Pub. Date: Oct. 5, 2023

(54) ERGONOMIC PUSHING SURFACE FOR ELECTRICAL COMPONENTS

(71) Applicant: Aptiv Technologies Limited, St. Michael (BB)

(72) Inventors: Horacio Herrera Leija, Saltillo (MX); Jorge Ivan Escamilla Rodriguez, Saltillo (MX); Pedro Yabur Pacheco, Saltillo (MX)

(21) Appl. No.: 17/855,994

(22) Filed: Jul. 1, 2022

Related U.S. Application Data
(60) Provisional application No. 63/327,506, filed on Apr. 5, 2022.

(51) Int. Cl. H01R 13/46; H01R 13/631

(52) U.S. Cl. CPC H01R 13/46; H01R 13/631

(57) ABSTRACT

An electrical connector includes a connector body defining a terminal cavity and a pair of curved push surfaces disposed opposite one another near distal edges of the connector body. The electrical connector is capable of meeting USCAR-25 Class 3 ergonomic criteria for push area.

### CROSS-REFERENCE TO RELATED APPLICATION

This application claims benefit of priority to U.S. Provisional Patent Application No. 63/327,506 filed on Apr. 5, 2022, the entire disclosure of each of which is hereby incorporated by reference.

### TECHNICAL FIELD

This disclosure is directed to an ergonomic pushing surface for electrical components, e.g., for small electrical connectors having a push surface of 150 mm² or less.

### BACKGROUND

As the size of automotive electrical connectors are decreased to reduce weight and packaging space required, the area on the connector available for an assembly operator, human or robotic, to push the connector into a mating connector decreases. This has made compliance with automotive industry standards for ergonomics, such as USCAR-25-3 issued by the United States Council for Automotive Research—Electrical Wiring Component Application Partnership (USCAR-EWCAP), difficult.

In electrical connectors, such as those used in automotive applications, there are many different connectors having different sizes and number of terminals. The size of the connector determines the USCAR-25 class of the connector without consideration of the number of terminals in the connector. The push surface of the connector that is used to mate the connector with a corresponding connector or device is important in vehicle assembly plants to provide an easy and ergonomic installation and removal process of the connector with the mating connector or device.

Smaller connectors may have difficulty meeting the design criteria recommended in USCAR-25 even in connectors that have a small number of terminals (depending on the terminal sizes), which may complicate the connector design and require additional steps in the assembly process, changes to assembly tools, or redesign of the connector to meet the recommended criteria.

The recommended push surfaces 12 of electrical connectors 10 according to the USCAR-25-3 standard are illustrated by the yellow shaded areas in FIG. 1.

### BRIEF SUMMARY

According to an embodiment, an electrical connector is provided. The electrical connector includes a connector body defining a terminal cavity and a pair of curved push surfaces disposed opposite one another near distal edges of the connector body.

In one or more embodiments of the electrical connector according to the previous paragraph, the curved push surfaces are integrally formed with the connector body.

In one or more embodiments of the electrical connector according to any one of the previous paragraphs, each of the curved push surfaces defines an arcuate shape.

In one or more embodiments of the electrical connector according to any one of the previous paragraphs, each of the curved push surfaces defines a friction enhancement feature.

In one or more embodiments of the electrical connector according to any one of the previous paragraphs, the friction enhancement feature includes an array of parallel ribs protruding from the curved push surfaces.

In one or more embodiments of the electrical connector according to any one of the previous paragraphs, the friction enhancement feature includes an array of hemispherical projections protruding from the curved push surfaces.

In one or more embodiments of the electrical connector according to any one of the previous paragraphs, the friction enhancement feature includes an array of chevron projections protruding from the curved push surfaces.

In one or more embodiments of the electrical connector according to any one of the previous paragraphs, the friction enhancement feature includes an array of cruciform projections protruding from the curved push surfaces.

In one or more embodiments of the electrical connector according to any one of the previous paragraphs, the electrical connector further comprises a connector locking device. Each of the curved push surfaces are located on opposite sides of the connector locking device.

In one or more embodiments of the electrical connector according to any one of the previous paragraphs, the pair of curved push surfaces meet USCAR-25 Class 3 push area criteria.

In one or more embodiments of the electrical connector according to any one of the previous paragraphs, the connector body defines cavities under the pair of curved push surfaces configured to accommodate fingers or service tools.

In one or more embodiments of the electrical connector according to any one of the previous paragraphs, the electrical connector further includes an electrical terminal disposed within the terminal cavity.

### DESCRIPTION OF THE DRAWINGS

The present invention will now be described by way of example with reference to the accompanying drawings, in which:

FIG. 1 illustrates recommended push surfaces of electrical connectors according to the USCAR-EWCAP standards;

FIG. 2 illustrates a perspective view of an electrical connector having ergonomic push surfaces according to some embodiments;

FIG. 3 illustrates a top view of the electrical connector having ergonomic push surfaces of FIG. 2 according to some embodiments;

FIG. 4 illustrates a bottom view of the electrical connector having ergonomic push surfaces of FIG. 2 according to some embodiments; and

FIGS. 5-9 illustrate close up perspective views of the various ergonomic push surfaces of the electrical connector of FIG. 2 according to some embodiments.

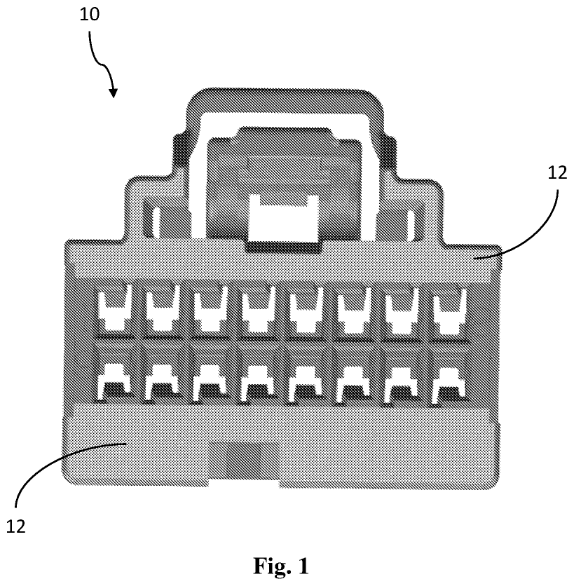

### DETAILED DESCRIPTION

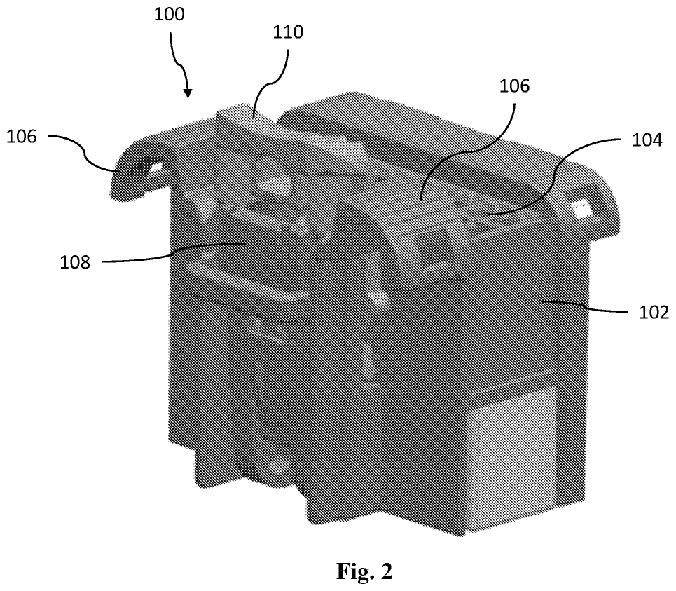

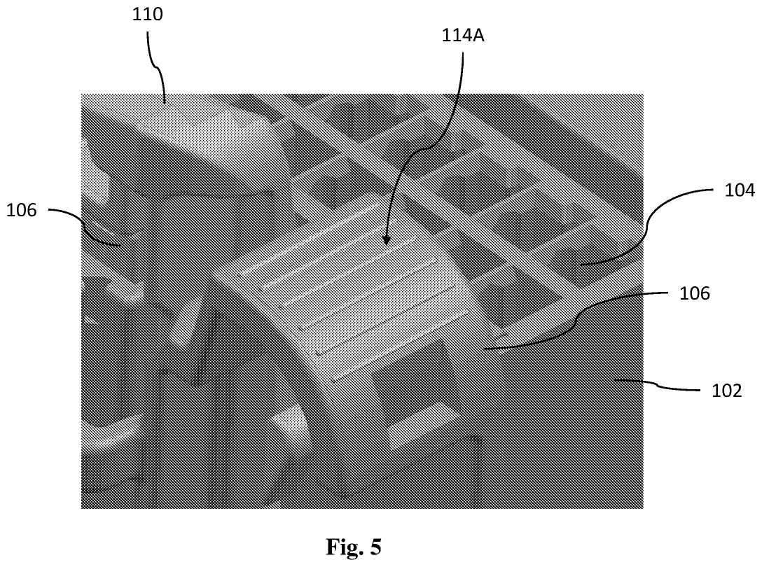

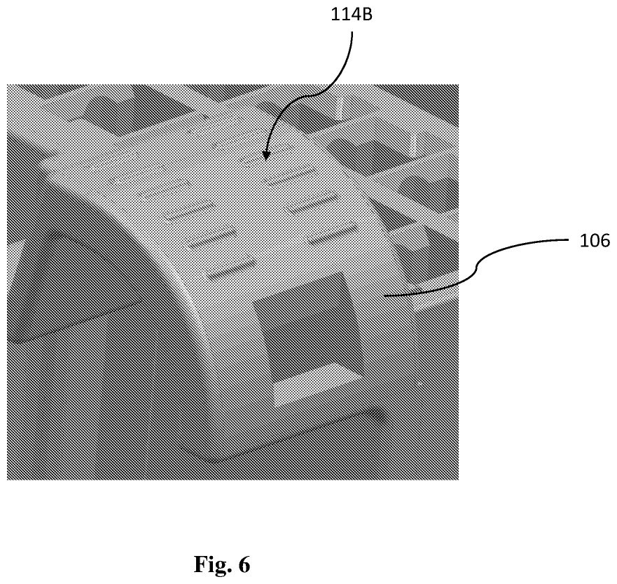

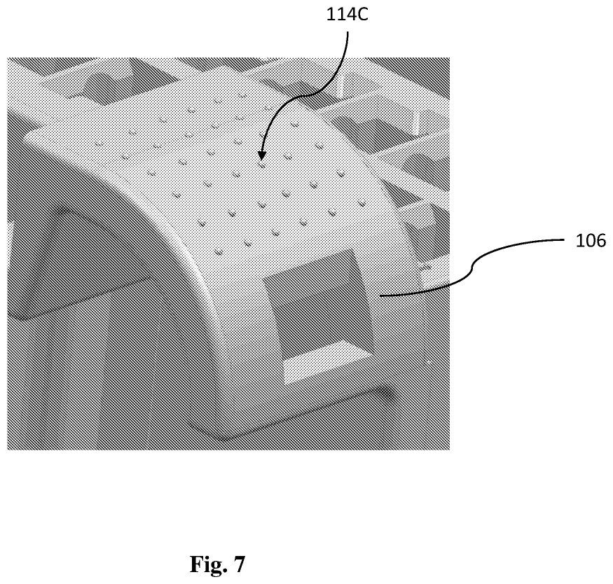

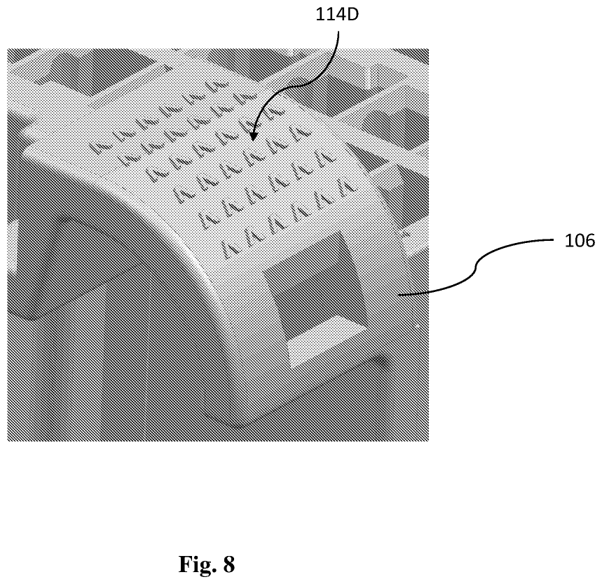

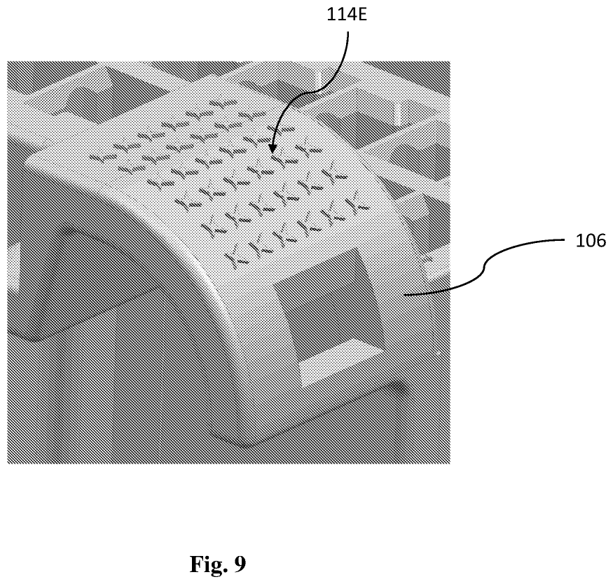

FIGS. 2-5 show a non-limiting example of an electrical connector, hereafter referred to as the connector 100, having a connector body 102 which defines a plurality of terminal cavities 104. The connector also includes curved ergonomic push surfaces 106. These push surfaces 106 are disposed opposite one another on each side of a connector locking device 108 and a connector position assurance device 110 near distal edges of the connector body 102. The push surfaces 106 each have an arcuate shape forming laterally rounded edges 112 that are configured to avoid high pressure points applied to an assembly operator's fingers as the connector 100 is mated with a corresponding connector (not shown) by spreading the force applied by the assembly operator over a larger area than would otherwise be available on a same size connector having flat push surfaces. This shape of the push surfaces 106 may help to reduce fatigue for the assembly operator caused by performing many assembly operations. The push surfaces 106 also define a plurality of friction enhancement features 114 that are configured to increase the coefficient of friction between the push surfaces 106 and the assembly operator's fingers, thereby providing a more consistent grip. Non-limiting examples of the friction enhancement features include arrays of ridges 114A, 114B, see FIGS. 5 and 6, hemispherical dots 114C, see FIG. 7, chevrons 114D, see FIG. 8, or crosses 114E, see FIG. 9. Other friction enhancement features configured to increase the coefficient of friction between the push surfaces 106 and an assembly operator, such as a roughened or textured surface, may also be utilized. These friction enhancement features may also be effective to provide better grip when a gripping device of an automated assembly device is used instead of the fingers of a human assembly operator. The push surfaces 106 illustrated herein are capable of meeting Class 3 criteria (150 mm² surface with a minimum of 50 mm² push surface provided on each opposing grip surface) of the USCAR-25-3 standard issued by the United States Council for Automotive Research—Electrical Wiring Component Application Partnership, published Mar. 10, 2016 by SAE International.

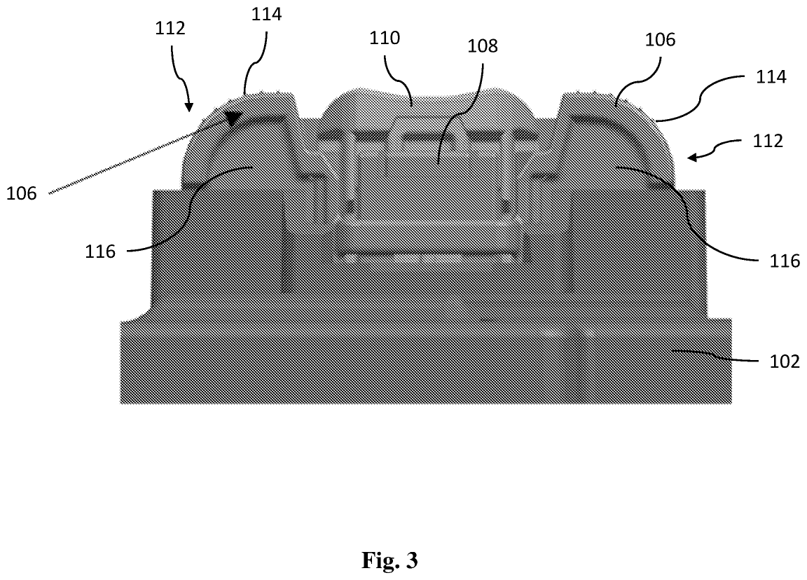

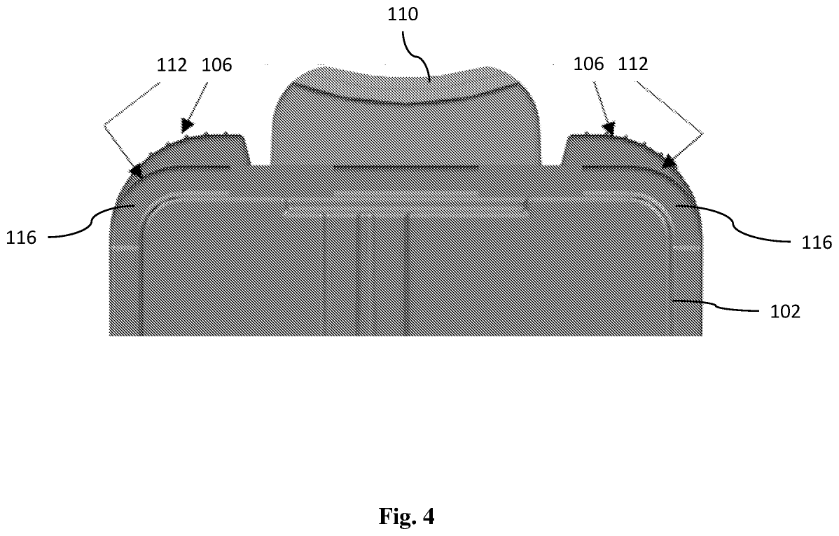

As best shown in FIGS. 3 and 4, the connector 100 also defines cavities 116 located under the push surfaces 106 that may accommodate fingertips or service tools to more easily manipulate the connector 100 for disconnection and/or removal. These cavities 116 may also serve as a protective device a connector position assurance (CPA) device when the CPA device is in an engaged position.

While the invention has been described with reference to an exemplary embodiment(s), it will be understood by those skilled in the art that various changes may be made, and equivalents may be substituted for elements thereof without departing from the scope of the invention. In addition, many modifications may be made to adapt a particular situation or material to the teachings of the invention without departing from the essential scope thereof. Therefore, it is intended that the invention is not limited to the disclosed embodiment(s), but that the invention will include all embodiments falling within the scope of the appended claims.

As used herein, ‘one or more’ includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Additionally, while terms of ordinance or orientation may be used herein these elements should not be limited by these terms. All terms of ordinance or orientation, unless stated otherwise, are used for purposes distinguishing one element from another, and do not denote any particular order, order of operations, direction or orientation unless stated otherwise.

1. An electrical connector, comprising:
a connector body defining a terminal cavity; and
a pair of curved push surfaces disposed opposite one another near distal edges of the connector body.

2. The electrical connector according to claim 1, wherein the curved push surfaces are integrally formed with the connector body.

3. The electrical connector according to claim 1, wherein each of the curved push surfaces defines an arcuate shape.

4. The electrical connector according to claim 1, wherein each of the curved push surfaces defines a friction enhancement feature.

5. The electrical connector according to claim 4, wherein the friction enhancement feature includes an array of parallel ribs protruding from the curved push surfaces.

6. The electrical connector according to claim 4, wherein the friction enhancement feature includes an array of hemispherical projections protruding from the curved push surfaces.

7. The electrical connector according to claim 4, wherein the friction enhancement feature includes an array of chevron projections protruding from the curved push surfaces.

8. The electrical connector according to claim 4, wherein the friction enhancement feature includes an array of cruciform projections protruding from the curved push surfaces.

9. The electrical connector according to claim 1, wherein the electrical connector further comprises a connector locking device and wherein each of the curved push surfaces are located on opposite sides of the connector locking device.

10. The electrical connector according to claim 9, wherein the electrical connector further comprises a connector position assurance device and wherein each of the curved push surfaces are located on opposite sides of the connector position assurance device.

11. The electrical connector according to claim 1, wherein the pair of curved push surfaces meet USCAR-25-3 Class 3 push area criteria.

12. The electrical connector according to claim 1, wherein the connector body defines cavities under the pair of curved push surfaces configured to accommodate fingers or service tools.

13. The electrical connector according to claim 1, further comprising an electrical terminal disposed within the terminal cavity.
